(19) United States
(12) Patent Application Publication
(10) Pub. No.: US 2012/0256526 A1
(43) Pub. Date: Oct. 11, 2012

(54) FIBER OPTIC CABINET

(76) Inventors: Jian Wei, Shanghai (CN); Yifeng Cui, Shanghai (CN); Peiyou Xiong, Shanghai (CN); Yingyu Wang, Shanghai (CN); Bin Lu, Shanghai (CN); Bin Yu, Shanghai (CN); Zhiyong Xu, Shanghai (CN); Yingliang Peng, Shanghai (CN)

(21) Appl. No.: 13/517,382

(22) PCT Filed: Dec. 30, 2009
(86) PCT No.: PCT/CN2009/001587

§ 371 Date: Jun. 20, 2012

(51) Int. Cl. G02B 6/44

(52) U.S. Cl. 312/237; 312/223.6

(57) ABSTRACT

The present invention relates to a fiber optic telecommunication cabinet for use in fiber optic telecommunication networks. The fiber optic telecommunication cabinet comprises a base and a housing. The housing defines an internal cavity from an open first end that extends longitudinally to a closed second end. The base is configured for attachment to the open first end of the housing to provide an enclosed configuration. The base has a plurality of ports passing through the base to allow passage telecommunication cables into the fiber optic cabinet. A center support column extends from the base from the base. The fiber optic cabinet includes a plurality of patch panel frames disposed radially around the center support column and a patch cord management plate attached to the center support column above the plurality of patch panel frames.

### THE FIELD OF THE INVENTION

The present invention generally relates to a facility for use in the outside plant for a fiber distribution system. More specifically, present invention relates to a fiber optic cross-connect cabinet.

### BACKGROUND OF THE INVENTION

In recent years, consumer demand for content providers such as telecommunication and cable companies to offer bundled (Triple Play) high speed data, video, and voice service has increased drastically. As a result, the amount of telecommunication equipment and components required in the Outside Plant Network (OSP) has increased as well. These components and equipment require a telecommunication fiber optic cabinet that can provide environmental protection.

In optical networks, a telecommunication fiber optic cabinet can be a fiber optic cabinet to provide fiber splicing, cross connection, protection and other functions. Most conventional fiber optic cabinets are located above ground level. Due to restrictions and requirements from various governmental entities (e.g., city municipalities), it has become increasingly difficult to obtain the required permits for the addition of above ground utility cabinets and fiber optic cabinets. In addition it can be expensive to install a wholly new underground fiber optic cabinet, thus specific interest has materialized to reduce the size while increasing the capacity and functionality of below ground fiber optic cabinet systems.

Because telecommunication lines, especially optical fiber cables, are frequently run under ground and are accessible via manholes, a high density optical fiber cabinet which is easily accessible from a manhole will enhance the deployment of optical fiber networks in locations where above ground placement of cabinets is not possible.

### SUMMARY OF THE INVENTION

The present invention relates to a fiber optic telecommunication cabinet for use in fiber optic telecommunication networks. The fiber optic telecommunication cabinet comprises a base and a housing. The housing defines an internal cavity from an open first end that extends longitudinally to a closed second end. The base is configured for attachment to the open first end of the housing to provide an enclosed configuration. The base has a plurality of ports passing through the base to allow passage telecommunication cables into the fiber optic cabinet. A center support column extends from the base. The fiber optic cabinet includes a plurality of patch panel frames disposed radially around the center support column and a patch cord management plate attached to the center support column above the plurality of patch panel frames.

The fiber optic telecommunication cabinet may also include a lower patch panel support structure attached to the center support column below the plurality of patch panel frames and an upper patch panel support structure attached to the center support column above the plurality of patch panel frames and below the patch cord management plate. Each of the plurality of patch panel frames can be slidably engageable with guide structures on the lower patch panel support structure and the upper patch panel support structure to facilitate installation of splices and interconnecting connectorized pigtails to a rear portion of fiber optic connector adapters disposed on the patch panel frames. Patch cords can be used to interconnect fiber optic connector adapters on the front side of the patch panel frame.

### BRIEF DESCRIPTION OF THE DRAWINGS

The present invention will be further described with reference to the accompanying drawings, wherein:

FIG. 1 shows an isometric view of an exemplary fiber optic cabinet in accordance with the present invention;

FIG. 2 shows an isometric view of an exemplary fiber optic cabinet of FIG. 1 with the fiber optic cabinet's housing removed;

FIGS. 3A and 3B show a close-up isometric of one exemplary securing mechanism for the fiber optic cabinet of FIG., 1;

FIG. 3C shows an isometric view of an alternative securing mechanism of an exemplary fiber optic cabinet in accordance with the present invention;

FIG. 4 shows an isometric view of the interior of an exemplary fiber optic cabinet in accordance with the present invention;

FIG. 5 shows an alternate partial isometric view of the interior of an exemplary fiber optic cabinet in accordance with the present invention;

FIG. 6 shows an alternate partial isometric view of the interior of an exemplary fiber optic cabinet in accordance with the present invention;

FIG. 7A shows a close-up view of lower patch panel support structures of an exemplary fiber optic cabinet in accordance with the present invention;

FIG. 7B shows a close-up view of upper patch panel support structures of an exemplary fiber optic cabinet in accordance with the present invention;

FIG. 8 shows a patch panel frame of an exemplary fiber optic cabinet in accordance with the present invention;

FIGS. 9A and 9B show an alternate partial isometric view of the interior of an exemplary fiber optic cabinet in accordance with the present invention;

FIG. 10A shows how the exemplary fiber optic cabinet situated in an underground vault when it is in service; and

FIG. 10B shows the fiber optic cabinet after it has been raised out of the underground vault through a manhole.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DESCRIPTION OF THE PREFERRED EMBODIMENTS

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “forward,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

The present invention is directed to a telecommunication fiber optic cabinet, in particular an underground fiber optic cabinet. Specifically, the exemplary fiber optic cabinet, described herein, is of a smaller size such that it can reside in a standard manhole. In particular, the fiber optic cabinet can be fitted to a lift that enables the fiber optic cabinet to be raised above ground level for easier access during installation and maintenance operations.

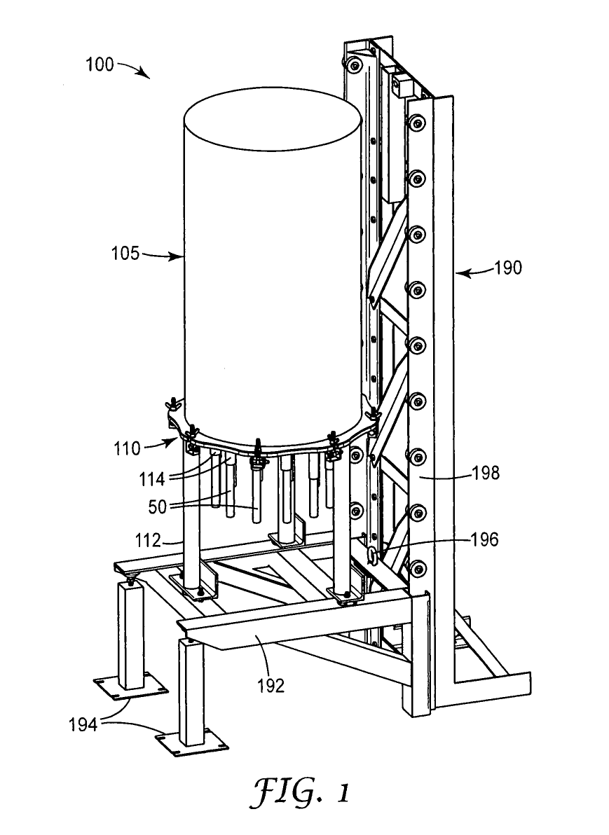

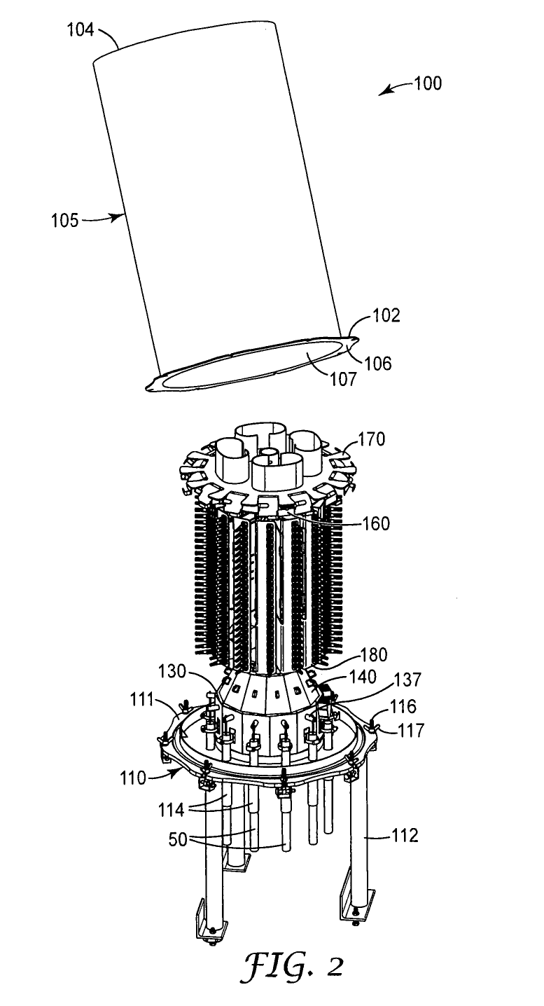

Referring to FIGS. 1 and 2, an exemplary telecommunication fiber optic cabinet in particular an underground fiber optic cabinet 100 according to one embodiment of the invention is illustrated. The fiber optic cabinet 100 includes a base 110 and a housing 105 removeably securable to the base 110. The housing 105 is hollow and defines a longitudinal internal cavity 107 (FIG. 2) extending from a first end 102 to a second end 104 of the housing 105. The internal cavity 107 has a circumferential shape in a direction transverse to the longitudinal direction. An opening at the first end 102 of the housing 105 is shaped and sized to fit over and engage with the base 110 in a conventional manner. When engaged, the base 110 and housing 105 provide protection (i e, an environmental seal) for the internal components of the fiber optic cabinet 100 from weather, insects and other external hazards.

The base 110 and housing 105 can include mating flanges 111, 106, respectively, to facilitate securing of the housing to the base. A sealing member 115, for example an O-ring, may be disposed on or in one of the housing mating flange 106 or the base mating flange 111 to enable an environmental seal to be formed between the base and the housing when the housing is secured to the base.

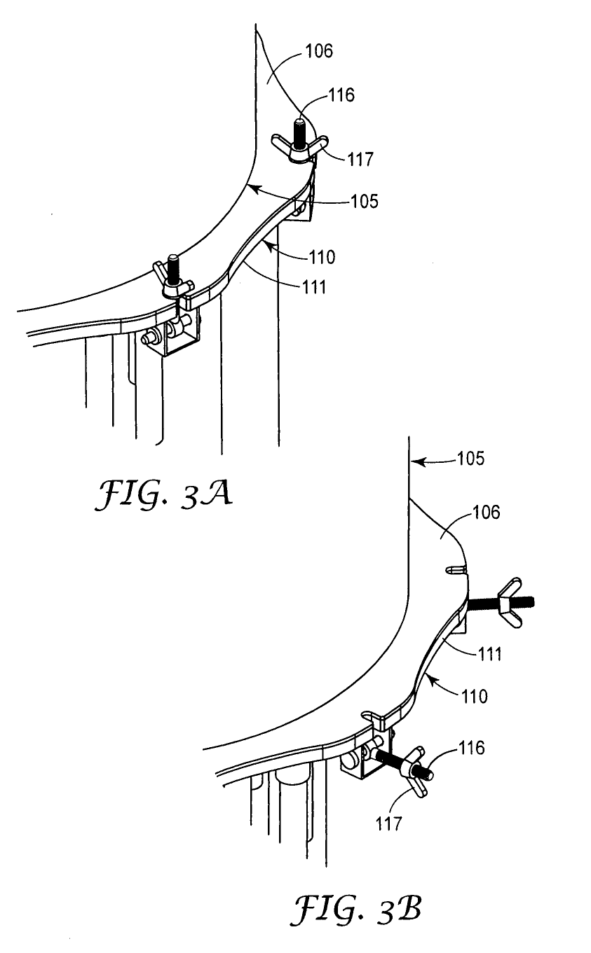

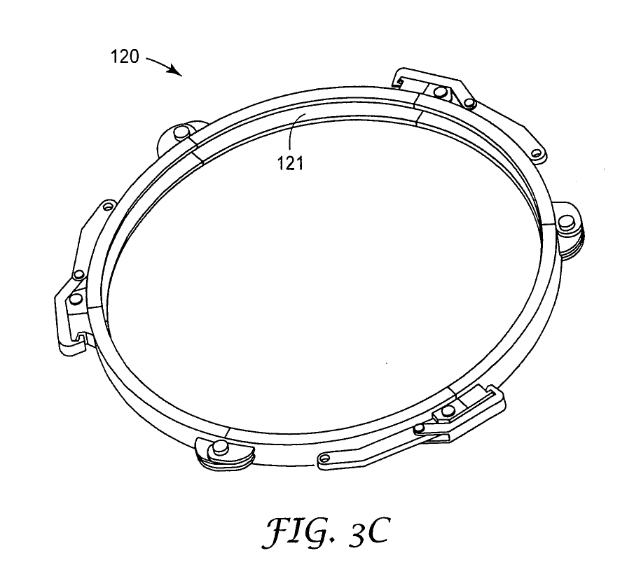

In one exemplary aspect, the housing 105 can be secured to the base 110 by a wing nut 117 attached to a swiveling bolt 116 securing mechanism attached to one of the base and the housing. FIG. 3A shows the housing secured to the base by a plurality of bolt 116 and wing nut 117 pairs disposed around the perimeter of the base and the housing. FIG. 3B shows the housing resting on the base with the bolt 116 and wing nut 117 pairs in a loosened and swiveled out position so that the housing may be removed from the base. This securing mechanism provides for tool-less opening and closing of the fiber optic cabinet.

In an alternative aspect a clamping ring 120 (FIG. 3C) can be fitted over and around mating flanges 106, 111 of the housing 105 and base 110, respectively, to secure the housing to the base of the fiber optic cabinet. The clamping ring includes a channel 121 formed along its inside perimeter that can engage with the mating flanges 106, 111 when the mating flanges a disposed within the channel and the clamp is closed to secure the housing to the base.

In an exemplary aspect, the housing may have one or more handles (not shown) disposed around the outer circumference of the housing to facilitate the craftsman's removal of the housing from the base for installation of maintenance activities. Optionally, the housing may have an additional handle located on the top closed end of the housing for the same purpose.

The base 110 includes at least one port 114 for receiving a telecommunication cable 50. The ports 114 allow passage of a single cable, or multiple cables in combination with a sealing member as is known in the art. The base 110 may have one, two, or any other number ports 114 as is required for a particular fiber optic cabinet 100.

In the exemplary embodiment, the housing 105 and cavity 107 therein can have an elliptical transverse cross-section. In the exemplary aspect shown in FIG. 2, the housing 105 and cavity 107 therein can have a substantially circular transverse cross-section, and having a closed second end 104. The base 110 generally has a shape similar to the cross-section of the base so that a reliable seal is made when the housing and the base are secured to one another. Thus base 110 can have a substantially circular cross-section in the transverse direction that matches with the shape of the open end of the housing 105. However, in practice, the shapes of the base 110 and housing 105 are not so limited, and in other embodiments the housing 105 and base 110 may have other shapes and cross-sections. For example, shape of the transverse cross-section of the housing 105 and base 110 may be substantially circular, rectangular, square, or any other shape as is required or desired for a particular application. The closed second end 104 of the housing 105 may likewise be any suitable shape. In other embodiments, the closed second end 104 of the housing 105 is not monolithically formed with the remainder of the housing 105, as shown in the illustrated embodiment. For example, in other embodiments the housing 105 can comprise an assembly of components, such as a longitudinal hollow body having two open ends, wherein a cap or other similar device is used to form the closed second end 104. In one embodiment, the housing 105 can have internal or external rib members in applications where required to meet external pressure requirements.

Base 110 can further comprise a plurality of legs 112 to keep the main body of the fiber optic cabinet elevated at a sufficient height to allow the telecommunication cables 50 to freely enter and exit the ports 114 disposed within the base. In FIGS. 1 and 2, fiber optic cabinet 100 is shown as having three legs 112 extending from base 110. Those skilled in the art will recognize that there may be other suitable configurations that will enable the fiber optic cabinet to be stably supported.

In an exemplary embodiment, the fiber optic cabinet 100 can be disposed on a lift 190. In particular, the legs 112 on the base 110 of the fiber optic cabinet can be attached to a lift platform of lift 192 by mechanical fasteners (e.g. bolts, not shown). Lift 190 can have an eyelet 196 attached to lift platform 192 to which a hook one the end of a cable from a winch may be connected to facilitate the raising of lift platform 192 along guide rails 198. The lift platform can rest on a pair of support braces 194 when the fiber optic cabinet 100 is disposed in an underground location. The support braces in conjunction with the lift provide a stable support structure for the fiber optic cabinet.

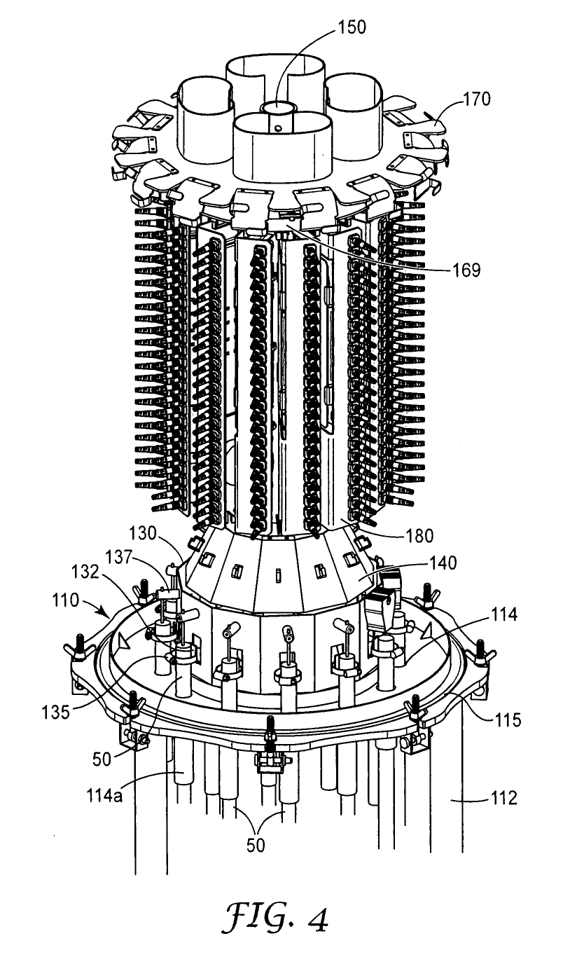

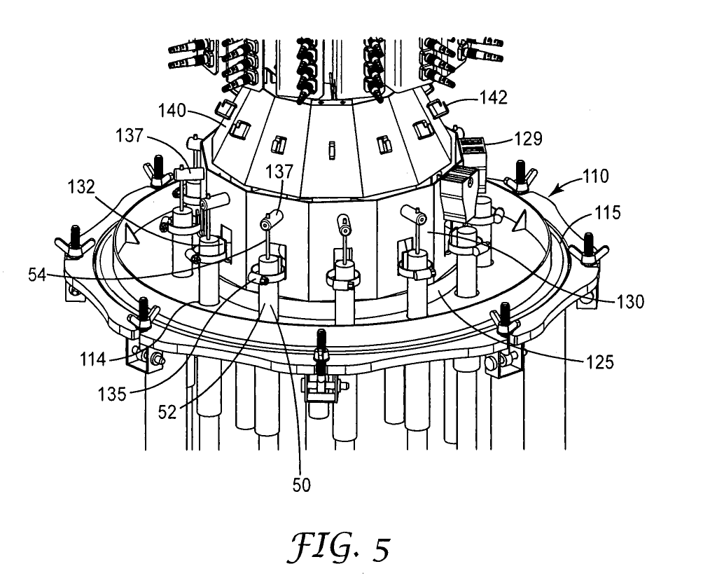

Referring to FIG. 4, telecommunication cables 50 enter the fiber optic cabinet 100 through ports 114. The ports allow passage of a single cable, or multiple cables in combination with a sealing member as is known in the art. For purposes of clarity, the invention is described herein as used with telecommunication cables or simply “cables” having one or more telecommunication lines therein. However, such use is exemplary only, and it is understood and intended that the present invention is equally suitable for use with other types of cables including, but not limited to, electrical power cables, optical fiber cables, copper wire cables, coaxial cables, drop lines, branch lines, and distribution lines, to name a few. The telecommunication cable 50 can have a semi-rigid outer sheath 52 (FIG. 5) surrounding at least one buffer loose buffer tube and at least one strength member 54. One to twelve optical fibers in the form of a ribbon or as individual buffer coated fibers may reside in the buffer tube surrounded by a water-blocking gel or grease. The strength members may be either semi-rigid rods or a collection of loose fibers e.g. made of aramid fibers.

Each port 114 case a tubular portion 114a extending from the lowers side of the base. A collapsible protective sleeve (not shown) may be fitted over the tubular portion and extend over a length of cable to provide a seal between the seal and the telecommunication cable entering the fiber optic cabinet. In an exemplary embodiment, ports may be oriented concentrically with the outer edge of the base. In an alternative embodiment, sealing can be provided by an inlet device as described in published U.S. Patent Publication No, 2009/0060421A1. If an inlet device as described is to be used in conjunction with the fiber optic cabinet of this disclosure, the port will have a complimentary structure to accept the inlet device. In an alternative embodiment, the ports in the base of the optical fiber cabinet can be in the form of a knockout such that they are sealed prior to a cable being introduced into the fiber optic cabinet. When a cable is introduced into the fiber optic cabinet, the craftsman doing the installation will remove the knock-out plug and insert a port adapter, which is compatible with the sealing method or device to be used, into the hole resulting from the removal of the knock-out plug.

Referring to FIGS. 4 and 5, once the cable enters the optical fiber cabinet, the cable can be secured to a strain relief ring 130. The strain relief ring can have a plurality of anchors 132 disposed around the ring such that each anchor aligns with one of the ports through base 110. Each cable can be secured to a corresponding anchor by fastening device 135 such as a hose clamp or a cable tie around the sheath 52 of the cable. Additionally, strain relief ring 130 can include a strength member retention feature 137. The strength member retention feature can be in the form of a peg that extends outward from the surface of strain relief ring 130 over each port 114. The peg can have a vertical hole drilled through the peg for the insertion of a rigid rod style strength member. The strength member may be secured within the hole by a fixing device, such as a screw, inserted into the end of the peg and tightened against the strength member such that the strength member is secured between the end of the fixing device and the wall of the hole through the peg. Alternatively, the peg of strength member retention feature 137 can have a notch formed therein for the securing of aramid yarn type strength members. In this embodiment, the aramid yarns can be wrapped around strength member retention feature and tied to secure them to the peg of strength member retention feature.

Strain relief ring 130 can be secured to the base 110 by one or more mounting bracket portions (not shown) extending inward from the bottom interior edge of the strain relief ring. The mounting bracket portions can be configured to be secured to the base by bolts or screws. In other embodiments, the strain relief ring 130 may be secured to the base 110 by any conventional mechanism including, but not limited to bolts, screws, interlocking elements on the strain relief ring 130 and base 110, adhesive, or any other suitable devices or materials. In one exemplary aspect, strain relief ring 130 may be used for a grounding connection. When the strain relief ring 130 is used as a ground connection, a nonconductive insulation layer 125 may be disposed between strain relief ring 130 and base 110. The insulation layer isolates the ground connection from other metal portions of the fiber optic cabinet which helps ensure a safe operating environment for the craftsman that is installing or doing maintenance work for the fiber optic cabinet. The nonconductive insulation layer can be formed from a nonconductive rubber material, a phenolic resin such as a Bakelite® material which is available from Hexion Specialty Chemicals (Columbus, Ohio, USA), an insulating ceramic material or other polymer insulating material.

In applications where fiber ribbon cables are used, a furcation device 129 can be used to facilitate routing of the fiber ribbon cables. The furcation device can be secured to strain relief ring 130 as shown in FIG. 5.

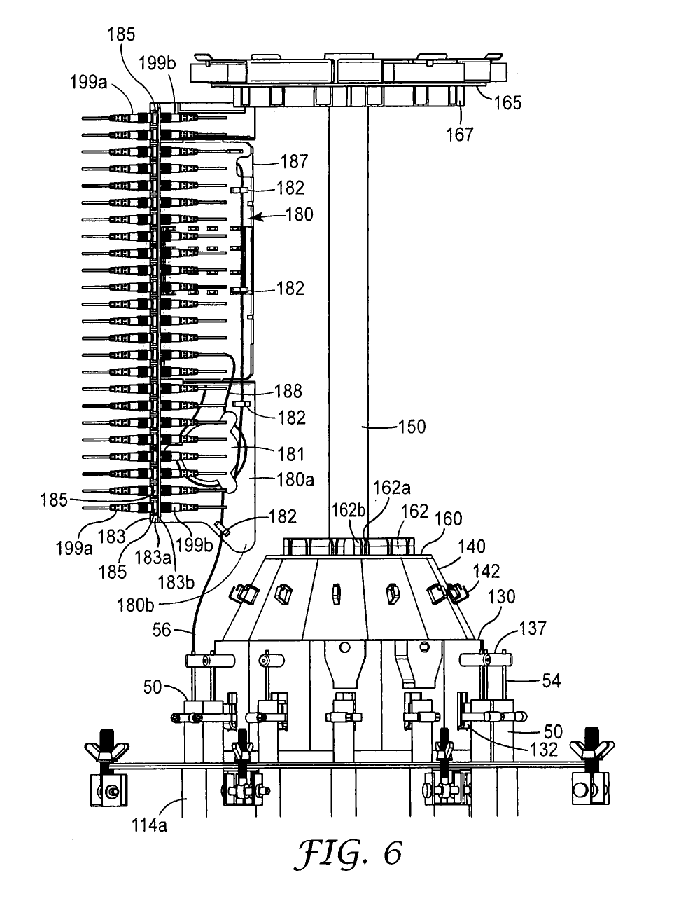

A central support column 150 (FIGS. 5 and 6) is also secured to base 110 to support and align additional components within the exemplary fiber optic cabinet. For example, the additional components can include a fiber routing ring 140, upper and lower patch panel support structures 160, 165 and a patch cord routing structure 170.

Fiber routing ring 140 is disposed above strain relief ring 130. Fiber routing ring 140 may be attached to the strain relief ring by one or more sets of flanges and mechanical fasteners (not shown) or may be attached to central column 150. Fiber routing ring 140 can have the shape of a truncate cone or a faceted truncated cone to facilitate the guiding of the optical fibers from where they enter the fiber optic cabinet to where they will enter the patch panel frame 180. In addition, the fiber routing ring prevents the kinking of the fibers when the patch panel frame is placed in its storage position as described below. Fiber routing ring 140 can have a plurality of fiber retention loops disposed on the surface of the fiber routing ring to guide fibers from one side of the fiber routing ring to another location on the fiber routing ring.

A lower patch panel support structure 160 is disposed on top of fiber routing ring 140. The lower patch panel support structure can be in the form of a plate having a center hole through the middle of the plate to accommodate the passage of central support column 150 through the lower patch panel support structure. Lower patch panel support structure 160 can be secured to the central support column by means of a flange arranged around the center hole of lower patch panel support structure and mechanical fasteners.

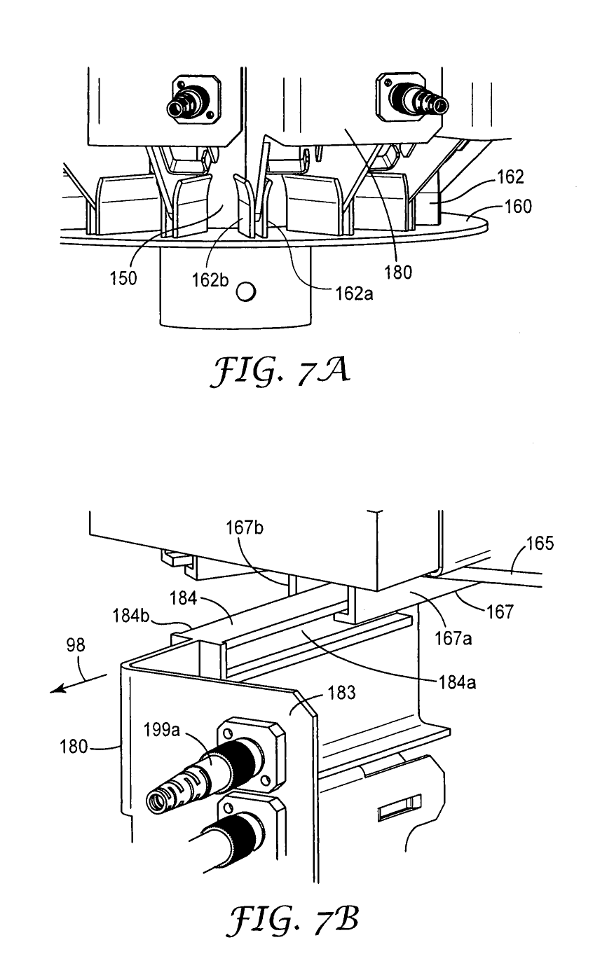

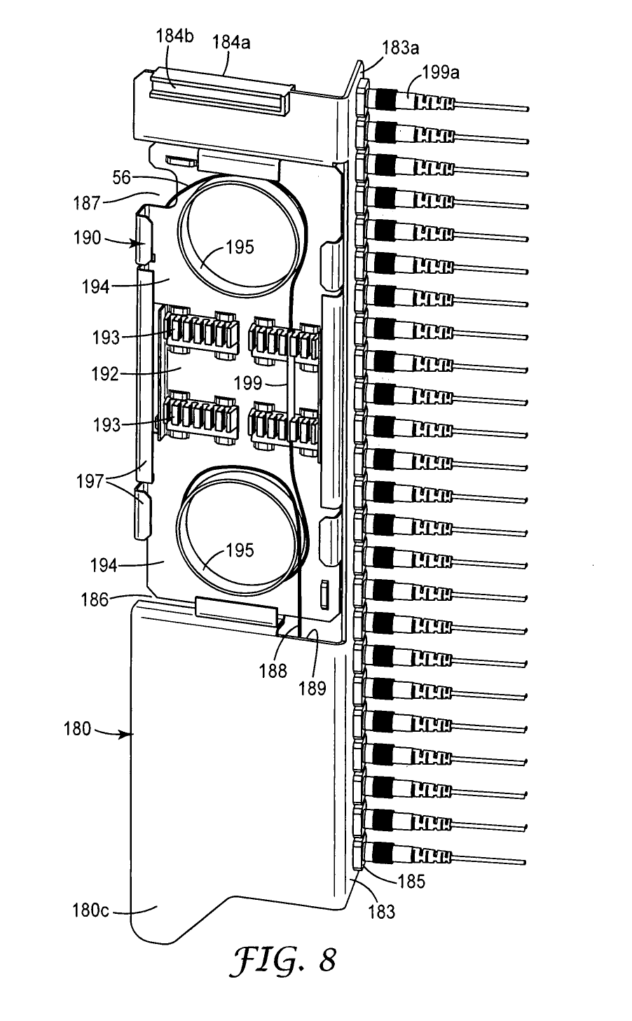

Referring to FIGS. 6 and 7A, lower patch panel support structure 160 includes a plurality of lower guide structures 162 to help position the patch panel frames 180 in the fiber optic cabinet when they are in a storage position. Each lower guide structure is comprised of two guide members 162a, 162b Guide members 162a, 162b are configured such that the lower end of a patch panel frame 180 resides between them when it is placed in its storage position as shown in FIG. 7A. To facilitate inserting the patch panel frame between the guide members, the guide members 162a, 162b arch away from each other at their top edge so that there is more space between them.

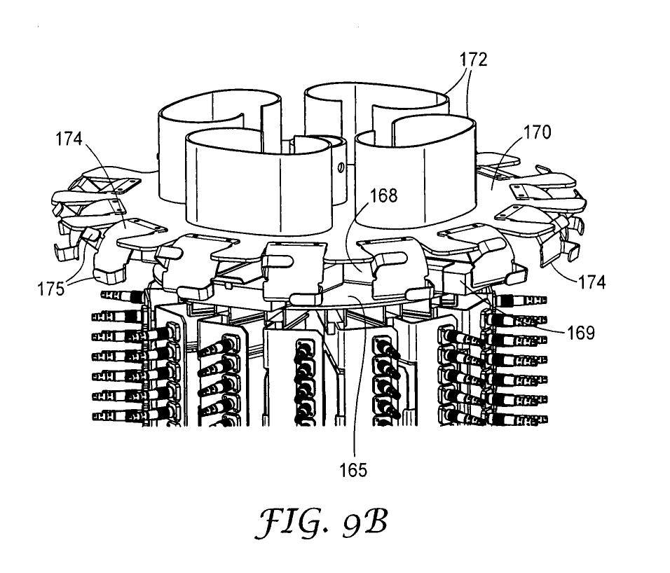

An upper patch panel support structure 165 is disposed above lower patch panel support structure 160 such that patch panel frame 180 may be fitted between them as shown in FIG. 6. The upper patch panel support structure can be in the form of a plate having a center hole through the middle of the plate to accommodate the passage of central support column 150 through the upper patch panel support structure. Upper patch panel support structure 160 can be secured to the central support column 150 by means of a flange 166 arranged around the center hole of upper patch panel support structure and mechanical fasteners (e.g. screws) as shown in FIG. 9A.

Referring to FIG. 7B, upper patch panel support structure 165 includes a plurality of upper guide structures 167 extending from the lower surface of the upper patch panel support structure. The upper guide structures help position the patch panel frames 180 in the fiber optic cabinet. Each upper guide structure 167 can be in the form of an open trough comprising of two L-shaped engagement members 167a, 167b. Engagement members 167a, 167b are configured to allow slidable engagement of a rail 184 on the top end of patch panel frame 180. Thus, patch panel frame 180 can be removed from the fiber optic cabinet by sliding it out of upper guide structure, as shown by arrow 98 in FIG. 7B, to allow easier access to the patch panel frame for making connections and splicing optical fibers. When the technician has made all of the necessary modifications on a particular patch panel frame, rail 184 is inserted into upper guide structure 167 and pushed in a direction opposite arrow 98 until the patch panel frame is in its storage position.

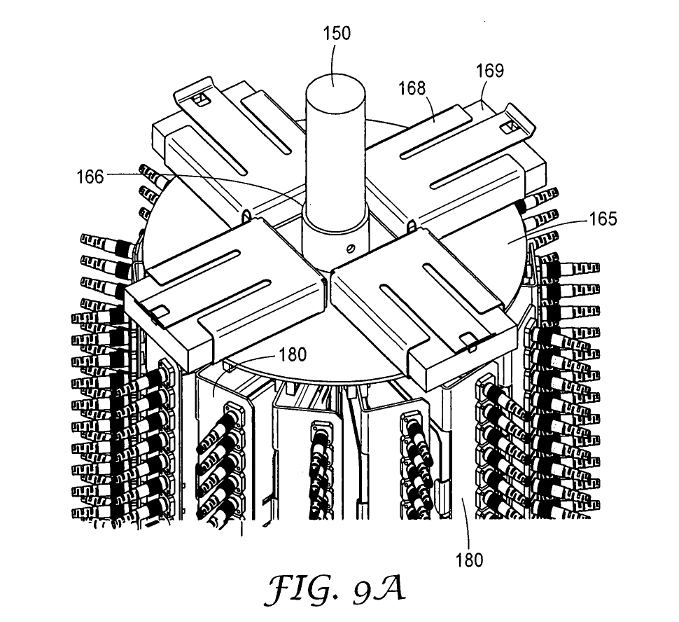

In this configuration, the patch panel frames 180 are positioned radially with respect to the central support column 150. In the exemplary embodiment shown in FIGS. 6 and 8, patch panel frame 180 has an L-shaped configuration having a first section 180a and a shorter second section 183 attached approximately perpendicularly to the front edge of the first section. The first section 180a has a first side 180b and a second side 180c.

Fibers 56 from the telecommunication cable 50 enter the patch panel frame 180 on the first side 180b of the first section 180a (FIG. 6). The fibers are guided by guide rings 182 to passage 187 which allows the fibers to transition to the second side 180c of the first section 180a of the patch panel frame 180 (FIG. 8). The second side 180c of the patch panel frame 180 can be used to splice the optical fibers 56 from the telecommunication cables to fiber pigtails 188.

Referring now to FIG. 8, patch panel frame 180 can have a depression 186 to accommodate a splice tray 190. The splice tray can have the same general shape and size as depression 186 in patch panel frame 180. Splice trays are known in the art. An exemplary splice tray such as a 2524SR splice tray available from 3M Company (St. Paul, Minn.). The splice tray can include a splicing section 192 and at least one cable management section 194. The splicing section includes a splice holding device 193. The splice holding device can include one or more splice inserts, or the splice holding device can be an integrally molded with the splice tray to retain optical fiber splices 199 such as mechanical or fusion optical fiber splices. An exemplary mechanical splice is available as 3M™ Fibrlok™ II mechanical splice from 3M company (St. Paul, Minn.). The cable management section can include arcuate walls or hubs 195 for guiding the fibers and tabs (not shown) for retaining them. The splice trays 190 can be deep enough to allow multiple crossovers of fiber ribbons or fibers. The splice tray can accommodate at least a number of splices equal to the patching capacity of the patch panel frame. Overlapping tabs 197 formed on the sides of splice tray 190 can further assist in the management of fibers entering and exiting the splice tray. In one exemplary aspect, splice tray 190 can be molded from an injection-moldable thermoplastic polymer such as polycarbonate. Optionally, splice tray 190 may be fitted with a cover (not shown).

Fibers 56 from the telecommunication cable enter the splice tray through passage 187 and are routed to splice holding device where they are spliced (e.g. by a fusion splice) to a fiber pigtail 188. The optical fiber pigtail can be a length of 2 mm jacketed optical fiber that has been pre-connectorized with an optical fiber connector 199b (FIG. 6). The fiber pigtail 188 exits the splice tray and the second side 180c of patch panel frame 180 through opening 189.

Referring back to FIG. 6, fiber pigtail 188 enters from the second side of the patch panel frame 190 to the first side 180b of the patch panel frame through opening (not shown). The fiber pigtails can be wrapped around routing hub 181 prior to connector 199b on the end of the pigtail being plugged into optical fiber connector adapter 185 mounted on the second section 183 of patch panel frame 180. The routing hub ensures that the minimum bend diameter for optical fiber pigtail is not exceeded.

The second section 183 can be used to form a patch panel by disposing an array of optical fiber connector adapters 185 through the second section. The optical connectors 199b on the back side 183b of second section 183 of patch panel frame 180 are connected to the telecommunication cables 50 entering the fiber optic cabinet by pigtails 188 and are herein referred to as back side connections. The optical connectors 199a on the front side 183a of second section 183 of patch panel frame 180 are connected to patch cords which interconnect two back side connections within the fiber optic cabinet and are herein referred to as front side or patching connections.

Optical connectors 199a, 199b can be mounted on the end(s) of the fiber optic patch cords or the fiber pigtails. Optical connectors 199a, 199b may be connectors such as a SC, ST, FC, or LC style connectors, to name a few, and may be, for example, either a positive contact (PC) or an angled polished connector (APC) type of connector. Sample connectors include 3M™ No Polish Connector SC Plug, 3M™ Hot Melt LC Connector, and 3M™ CRIMPLOK™ ST SM 126 UM Connector, each of which is available from 3M Company (St. Paul, Minn.). Alternatively, optical connectors 199a, 199b can be a field mountable connector such as SC, ST, FC, or LC connectors, e.g. 3M™ SC No Polish Connector available from 3M Company (St. Paul, Minn.). In an alternative aspect, connectors 199a, 199b can be multi-fiber connectors such as an MPO, MTP or VF-45 style connector mounted on either a multi-fiber pigtail or patch cord.

In one exemplary embodiment, the patch panel frames can each include from 12 to about 48 optical fiber connector adapters 185 for interconnecting the optical fibers from the fiber optic cables with patch cords depending on the size of the optical fiber cabinet (i.e. the size and number of patch panel frames) and the connector format selected. The optical fiber connector capacity can be increased by using a smaller format connector such as an LC format connector or by changing the geometry of the patch panel frames e.g. modifying the length of the patch panel frame or the width of the second section of patch panel frame to accommodate a second column of connector adapters.

In one exemplary embodiment, the fiber optic cabinet can hold up to thirty patch panel frames fanning out radially from the central support column 150 of the fiber optic cabinet. In the exemplary embodiment shown in FIG. 2, the optical fiber cabinet has been designed to fit into a 650 mm diameter manhole and this optical fiber cabinet can hold up to 14 patch panel frames. More patch panel frames can be incorporated into larger optical fiber cabinets. For example, an optical fiber cabinet designed for a 710 mm manhole can accommodate up to twenty patch panel frames, while an optical fiber cabinet designed for an 820 mm manhole can accommodate up to thirty patch panel frames. In an alternative embodiment, one or more of the patch panel frames can be replaced by an equal number of direct splicing frames. The direct splicing frames can hold one or more splice trays to allow direct splicing (i.e. on a conventional splice tray attached to the direct splicing frame) between optical fiber cables or for splicing of fibers from the optical cables to optical modules within the fiber optic cabinet.

The fiber optic cabinet may also include one or more optical modules. In one exemplary aspect, the one or more optical modules 169 can be disposed within module holders 168 located on the top surface of upper patch panel support structure 165 as shown in FIG. 9A. Exemplary optical modules can include splitter modules, wavelength division multiplexer module and the like. In an alternative exemplary aspect, an optical module can be disposed within a module holders located on each patch panel frame.

A patch cord management plate 170 is mounted on the center support column 150 above the upper patch panel support structure 165 as shown in FIG. 9B. The patch cord management plate is guiding and storage of fiber patch cords. The patch cord management plate provides a convenient path for the fiber patch cord when connecting to fiber optic connector adapters located on opposite sides of the fiber optic cabinet. The patch cord management plate can have a plurality of C-shaped guides 172 disposed on its upper surface manage the routing of the patch cords. The edge of the patch cord management plate can be notched to accommodate a bend radius limiter 174 to ensure that the minimum bending radius of optical fiber patch cords as the patch cords enter and exit the patch cord management plate. The bend radius limiter 174 can have one or more tabs 175 that extend up and over the bend radius limiter 174 to retain the fiber patch cords in proximity to the bend radius limiter 174. In this way, the bend radius limiters also can help maintain the minimum bend radius of the path cords as well as protecting patch cords from damage when housing of the fiber optic cabinet is secured to the base, due in part that the bend radius limiters 174 are inset from the edge of the patch cord management plate. In an alternative aspect, a protective plate (not shown) can be mounted on the center support column 150 above the patch cord management plate 170 to help retain the patch cords within the patch cord management plate and protect them from being damaged when the housing is secured to the base of fiber optic cabinet.

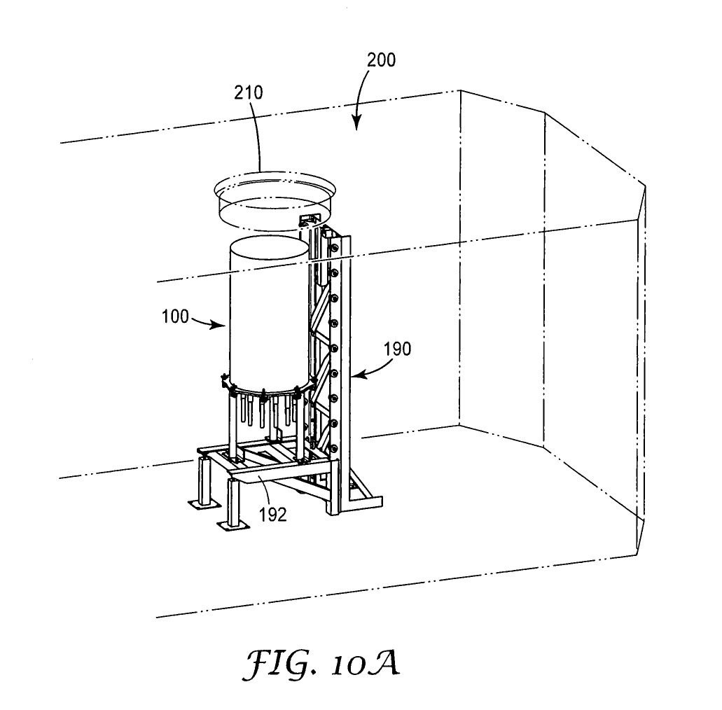

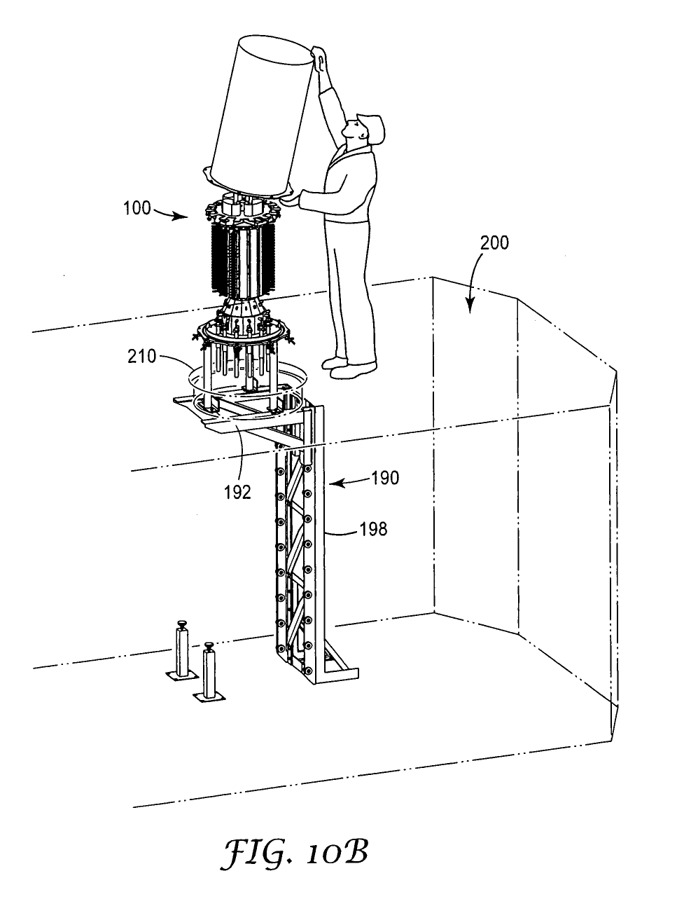

FIG. 10A shows how the exemplary fiber optic cabinet 100 would be situated on its lift 192 in an underground vault when it is in service. FIG. 10B shows the fiber optic cabinet after it has been raised out of the underground vault through manhole 210 using a hand winch (not shown). Being able to raise the fiber optic cabinet to ground-level, facilitates installation and maintenance activities. The lift can have an arrestor pin (not shown) to secure the lift platform to the guide rails in a raised position during installation and maintenance procedures. When work is completed, the arrestor pin can be released to allow the lift to be lowered returning the fiber optic cabinet to the underground vault.

Advantageously, the exemplary fiber optic cabinet disclosed herein utilizes a single length of patch cord to provide the necessary cross-connections within the fiber optic cabinet. Thus, simplifying the parts list associated with the exemplary fiber optic cabinet.

Although specific embodiments have been illustrated and described herein for purposes of description of the preferred embodiment, it will be appreciated by those of ordinary skill in the art that a wide variety of alternate or equivalent implementations may be substituted for the specific embodiments shown and described without departing from the scope of the present invention. Those with skill in the art will readily appreciate that the present invention may be implemented in a very wide variety of embodiments. This application is intended to cover any adaptations or variations of the embodiments discussed herein. Therefore, it is manifestly intended that this invention be limited only by the claims and the equivalents thereof.

What is claimed is:

1. A fiber optic telecommunication cabinet comprising:
a housing longitudinally extending from an open first end to a closed second end, the housing defining an internal cavity extending in the longitudinal direction;
a base configured for attachment to the open first end of the housing to provide an enclosed configuration, the base defining a plurality of ports passing through the base to allow passage telecommunication cables therethrough;
a center support column extending from the base;
a plurality of patch panel frames disposed radially around the center support column; and
a patch cord management plate attached to the center support column above the plurality of patch panel frames.

2. The fiber optic telecommunication cabinet of claim 1, further comprising a lower patch panel support structure attached to the center support column below the plurality of patch panel frames and an upper patch panel support structure attached to the center support column above the plurality of patch panel frames and below the patch cord management plate.

3. The fiber optic telecommunication cabinet of claim 2, wherein the plurality of patch panel frames are slidably engageable with guide structures on the lower patch panel support structure and the upper patch panel support structure.

4. The fiber optic telecommunication cabinet of claim 1, wherein each of the plurality of patch panel frames comprises a splice tray disposed on a first section of each of the plurality of patch panel frames

5. The fiber optic telecommunication cabinet of claim 1, wherein each of the plurality of patch panel frames has a plurality of fiber optic connector adapters disposed on a second section of each of the plurality of patch panel frames.

6. The fiber optic telecommunication cabinet of claim 5, further comprising a patch cord interconnecting two of the fiber optic connector adapters.

7. The fiber optic telecommunication cabinet of claim 1, further comprising at least one direct splicing frame.

8. The fiber optic telecommunication cabinet of claim 1, further comprising at least one optical module.

9. The fiber optic telecommunication cabinet of claim 1, further comprising a lift to raise the optic telecommunication cabinet out of an underground vault.
